(19) United States
(12) Patent Application Publication
(10) Pub. No.: US 2016/0377709 A1
(43) Pub. Date: Dec. 29, 2016

(54) DETERMINING AN OBJECT DISTANCE USING RADIO FREQUENCY SIGNALS

(71) Applicant: Aviacomm Inc., Sunnyvale, CA (US)

(72) Inventors: Hans Wang, Mountain View, CA (US); Tao Li, Campbell, CA (US); Binglei Zhang, San Jose, CA (US); Shih Hsiung Mo, San Jose, CA (US)

(73) Assignee: AVIACOMM INC., Sunnyvale, CA (US)

(21) Appl. No.: 14/790,776

(22) Filed: Jul. 2, 2015

Related U.S. Application Data
(60) Provisional application No. 62/042,722, filed on Aug. 27, 2014.

(51) Int. Cl. G01S 11/02; G01S 11/12; H04W 16/28

(52) U.S. Cl. CPC G01S 11/026; H04W 16/28; G01S 11/12

(57) ABSTRACT

An object-tracking system can compute a distance to a target object. During operation, the system can use a radio antenna to receive a first radio signal pattern from a direction of a target object. The system determines a time interval from the received radio signal pattern, and determines a velocity of the local system. The system then computes a distance to the target object based on the time interval and the velocity of the object-tracking device.

### RELATED APPLICATION

This application claims the benefit of U.S. Provisional Application No. 62/042,722, Attorney Docket Number AVC14-1004PSP, entitled “USING RF TECHNOLOGY TO DETERMINE DISTANCE,” by inventors Hans Wang, Tao Li, Binglei Zhang, and Shih Hsiung Mo, filed 27 Aug. 2014.

### BACKGROUND

Field

This disclosure is generally related to object detection. More specifically, this disclosure is related to scanning a radio signal pattern from a target object to determine a distance to the target object.

Related Art

Many real-time systems can benefit from determining an accurate distance to distant objects. For example, airplanes typically include a radar system that detects a distant object by reflecting a microwave signal off the target object. These radar systems can detect objects that are miles away, but require the target object to be of a significant size.

Many consumer products are being designed with smart features that provide valuable information to the user. For example, some modern automobiles are being equipped with sensors that can provide the driver with information on the automobile's surroundings. However, these sensors are typically limited to detecting when the automobile is veering out of the lane, or detecting when another vehicle is in the driver's blind spot.

Also, these blind spot detection systems are deployed with sensors that can only detect relatively close objects, such as using a sonar or infra-red (IR) system. These sonar and IR systems detect a target object by reflecting a sound or an IR beam off the target object, and hence require a clear line of sight to the target object. Unfortunately, these systems are not able to detect faraway objects, especially when the line of sight to the distant object is obscured by other objects. To make matters worse, IR systems can suffer from signal interference from the operating environment, which can lead to false positive readings or erroneous distance measurements.

Hence, it is not possible to use sonar and IR systems to reliably determine a distance to distant objects, such as an approaching car that is still a block away. Moreover, it is not feasible to deploy advanced object-detection systems such as radar on a consumer product like an automobile, given that these radar systems are typically large, consume an undesirably large amount of power, and are too expensive for the average consumer.

### SUMMARY

One embodiment provides an object-tracking system that facilitates computing a distance to a target object. During operation, the system can use a radio antenna to receive a first radio signal pattern from a direction of a target object. The system determines a time interval from the received radio signal pattern, and determines a velocity of the local system. The system then computes a distance to the target object based on the time interval and the velocity of the object-tracking device.

In some embodiments, the system can direct a directional antenna toward the target object receive a radio signal pattern from the target object, and not from other objects.

In some embodiments, the radio signal pattern includes a first signal pattern followed by a second signal pattern. Also, the time interval can include a difference between a first timestamp for the first signal pattern and a second timestamp for the second signal pattern.

In some embodiments, the time interval is determined from a signal frequency of the radio signal pattern.

In some embodiments, the system can compute a velocity of the target object, relative to a motion of the object-tracking device.

In some embodiments, the system can determine an adjusted time interval which accounts for the object-tracking device's motion, and computes an absolute velocity of the target object, based on the computed distance to the target object and the adjusted time interval.

In some embodiments, while computing the velocity, the system determines that the object is stationary responsive to determining that the adjusted time interval matches a predetermined time interval.

In some embodiments, the radio signal can include an infrared signal transmitted by the target object, a Wi-Fi signal transmitted by the target object, and/or a light signal transmitted by the object-tracking device and reflected off the target object.

### BRIEF DESCRIPTION OF THE FIGURES

FIG. 1 illustrates an exemplary multi-object environment in accordance with an embodiment.

FIG. 2 illustrates an exemplary object-tracking device that facilitates computing a distance to a target object in accordance with an embodiment.

FIG. 3A illustrates exemplary signals received from a target object in accordance with an embodiment.

FIG. 3B illustrates exemplary signals reflected off a target object in accordance with an embodiment.

FIG. 4 presents a flow chart illustrating a method for computing a distance to a target object in accordance with an embodiment.

FIG. 5 illustrates an exemplary computer system that facilitates computing a distance to a target object in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide an object-tracking device that solves the problem of determining an accurate distance to other nearby objects regardless of whether there exists a direct line of sight to a target object. The target object can use a radio transmitter to transmit a radio frequency (RF) signal pattern with well-defined intervals. The object-tracking device can use a radio receiver to detect these signal patterns, and determines a distance to the target object based on the signal pattern.

For example, a city's traffic lights may be equipped with radio transmitters which automobiles can scan for to detect their proximity. In some embodiments, the traffic light may transmit the RF signal when the light is yellow or red. This configuration can reduce the number of car accidents at an intersection, because the automobile can warn the driver when fast approaching a traffic light.

Also, because the signal pattern is carried over a radio frequency signal, the automobile's radio receiver can detect the signal even when the radio receiver does not have a direct line of sight to the transmitter. Oftentimes large trucks can block the visibility of the cars immediately behind them. Hence, installing these radio transmitters at traffic lights and stop signs can help a driver avoid running a red light when driving behind a large truck that runs a yellow light, or even a red light.

In some embodiments, the object-tracking device an also detect a distance to other object-tracking devices, such as those installed in other cars, motorcycles, bicycles, or any other stationary or moving objects. The object-tracking device can also use the detected signal patterns to determine a speed and direction of other moving objects.

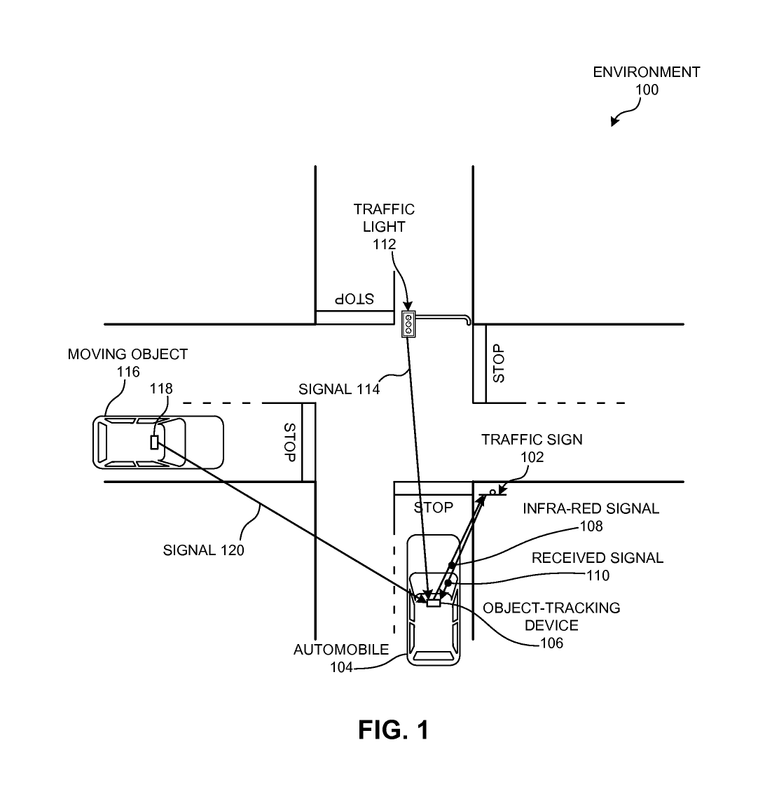

FIG. 1 illustrates an exemplary multi-object environment 100 in accordance with an embodiment. Specifically, environment 100 can include an automobile 104 that can compute the distance to various other objects via a radio signal transmitted by the other objects, or an infra-red signal reflected off a target object. For example, automobile 104 can track other automobiles, and can detect a distance to various objects that may require the automobile to stop. Automobile 104 can include an object-tracking device 106 which can orient a directional antenna toward a target object to receive radio signals from the target object, and not from other objects that are not being tracked.

In some embodiments, automobile 104 can compute a proximity to a stationary object that may require automobile to stop or yield. For example, a stationary object such as a traffic light 112 can include a wireless radio that broadcasts a radio signal 114 at a regular interval. Object-tracking device 106 can use signal 114 to determine a distance to traffic light 112, even when other objects may obscure a direct line of sight to traffic light 112. Hence, automobile 104 can accurately compute a distance to traffic light 112 even when a large truck or bus obscures a direct line of sight between object-tracking device 106 and traffic light 112.

Radio signal 114 can include information about traffic light 112, such as a unique identifier for traffic light 112, a state for traffic light 112, or any other information specific to traffic light 112. Moreover, radio signal 114 can also include any information which automobile 104 can use to compute a distance to traffic light 112, such as a timestamp for the radio signal, global positioning system (GPS) coordinates for traffic light 112, etc. When object-tracking device 106 of automobile 104 receives radio signal 114, object-tracking device 106 can compute the distance to traffic light 112, based on a time interval between two consecutive signals, a timestamp from radio signal 114, and/or the GPS coordinates of radio signal 114.

Moreover, object-tracking device 106 can compute a distance to a moving object 116, regardless of whether a direct line of sight exists between automobile 104 and moving object 116. For example, moving object 116 may include another automobile or motorcycle whose line of sight to automobile 104 is obscured by a building or another moving object. Automobile 104 can compute a distance to moving object 116 via a radio signal 120 broadcasted by a transmitter or object-tracking device 118 of moving object 116. Object-tracking device 118 can broadcast a radio signal 120 at a regular interval, and object-tracking device 106 can compute the distance to moving object 116 based on a time interval between two consecutive signals patterns of signal 120, a timestamp from radio signal 120, and/or the GPS coordinates of radio signal 120. Object-tracking device 106 can also compute a velocity of moving object 116 based on consecutive signal patterns of signal 120. This velocity can include, for example, a speed and a direction of moving object 116.

In some embodiments, object-tracking device 106 can determine a distance to any other object that does not itself broadcast radio signals. For example, some intersections without a traffic light 112 can use a traffic sign 102 (e.g., a stop sign) to control the flow of traffic across the intersection. Automobile 104 can determine an accurate position of the road at which it needs to stop or yield by computing a distance to traffic sign 102. To compute this distance, object-tracking device can transmit an infra-red signal 108 directed toward traffic sign 102, and uses the reflected signal 110 (which reflects off traffic sign 102) to compute the distance to traffic sign 102.

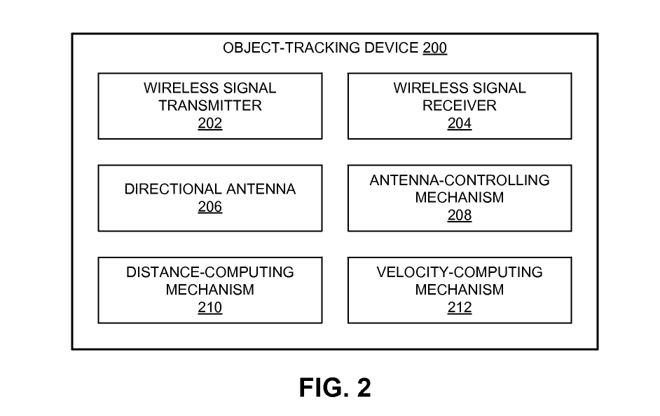

FIG. 2 illustrates an exemplary object-tracking device 200 that facilitates computing a distance to a target object in accordance with an embodiment. Object-tracking device 200 can comprise a plurality of modules which may communicate with one another via a wireless communication channel. Object-tracking device 200 may be realized using one or more integrated circuits, and may include fewer or more modules than those shown in FIG. 2. Further, object-tracking device 200 may be integrated in a computer system, or realized as a separate device which is capable of communicating with other computer systems and/or devices. Specifically, object-tracking device 200 can comprise a wireless signal transmitter 202, a wireless signal receiver 204, a directional antenna 206, an antenna-controlling mechanism 208, a distance-computing mechanism 210, and a velocity-computing mechanism 212.

In some embodiments, wireless signal transmitter 202 can transmit a radio frequency (RF) signal, such as a Wi-Fi signal. In some other embodiments, wireless signal transmitter 202 can transmit a light signal, such as an infra-red signal. Wireless signal receiver 204 can detect or receive the wireless RF or light signals transmitted by a wireless signal transmitter of a target object, or reflected off the target object. Directional antenna 206 can include a beam-forming antenna, or any antenna which can focus the incoming wireless signals to those transmitted by the target object. Antenna-controlling mechanism 208 can control the direction toward which directional antenna 206 is directed, which focuses the direction from which receiver 204 receives wireless signals.

Moreover, distance-computing mechanism 210 can compute a distance to a target object based on signals received from the target object, and velocity-computing mechanism 212 can compute a velocity and/or direction of the target object based on the signals received from the target object and the orientation of the directional antenna.

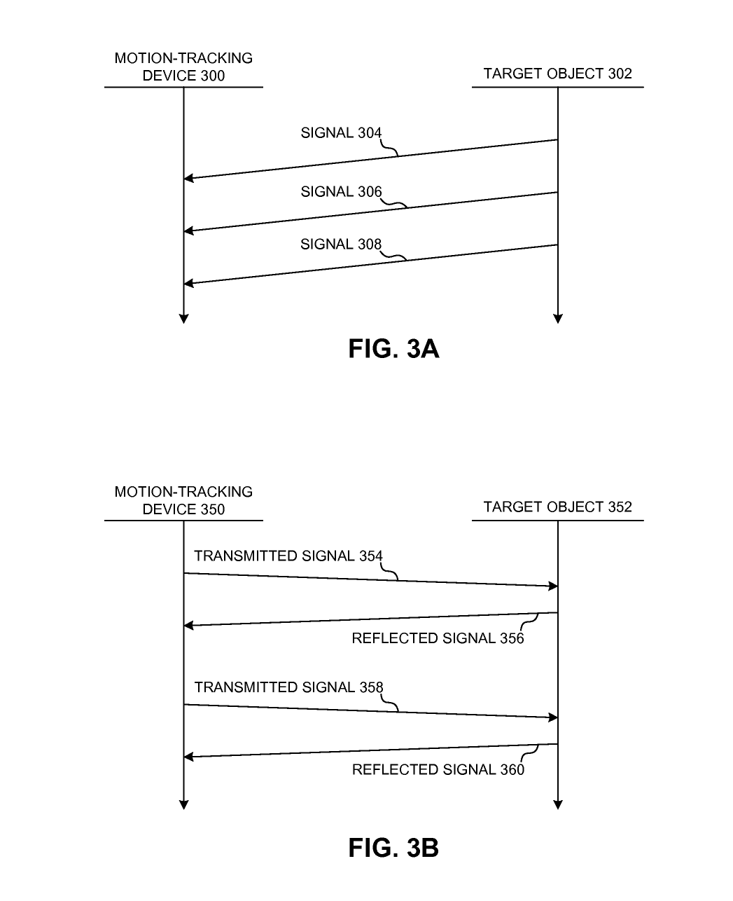

FIG. 3A illustrates exemplary signals received from a target object 302 in accordance with an embodiment. During operation, target object 302 can transmit signals 304, 306, and 308 at a predetermined time intervals. Object-tracking device 300 can orient its local directional antenna toward target object 302, and determines a timestamp for each received signal. In some embodiments, each signal 304, 306, and 308 includes information about target object 302, and includes a timestamp at which target object 302 transmitted the wireless signal. To compute the distance to target object 302, object-tracking device 300 first computes a signal transmission time for signal 304 by computing a difference between a timestamp included in signal 304 and the timestamp at which signal 304 was received. Object-tracking device 300 then computes the distance to target object 302 by multiplying the transmission time to a predetermined speed of the wireless signal (e.g., the speed of light).

Object-tracking device 300 can also compute a velocity of target object 302 by determining a difference between the signal-receiving times for consecutive signals from target object 302. For example, object-tracking device 300 can determine a time interval between signal 304 and signal 306, and computes the relative velocity of target object 302 based on the Doppler effect. The relative velocity is the velocity of target object 302, relative to the velocity of object-tracking device 300.

FIG. 3B illustrates exemplary signals reflected off a target object 352 in accordance with an embodiment. During operation, object-tracking device 350 can transmit a signal 354 toward target object 352, and waits to receive a signal 356 reflected off target object 352. In some embodiments, signals 354 and 356 can include a light signal, such as an infra-red signal. Object-tracking device 350 determines the transmission time for signal 354 by dividing by half the time interval between the transmission timestamp for signal 354 and the receive timestamp for signal 356. Motion tracking device 350 then computes the distance to target object 352 by multiplying the transmission time to the predetermined speed of the wireless signal (e.g., the speed of light).

In some embodiments, motion tracking device 350 can compute a velocity of target object 352 by reflecting another signal off target object 352 to determine an updated distance to target object 352. For example, device 350 can transmit a directional signal 358 toward target object 352, and determines a time interval between signal 358 and the receive time for its reflected signal 360. Object-tracking device 350 then computes the updated distance to target object 352 using the new time interval, and computes the relative velocity of target object 352 by dividing the change in distance to target object 352 by a time interval between the first reflected signal 356 and the second reflected signal 360.

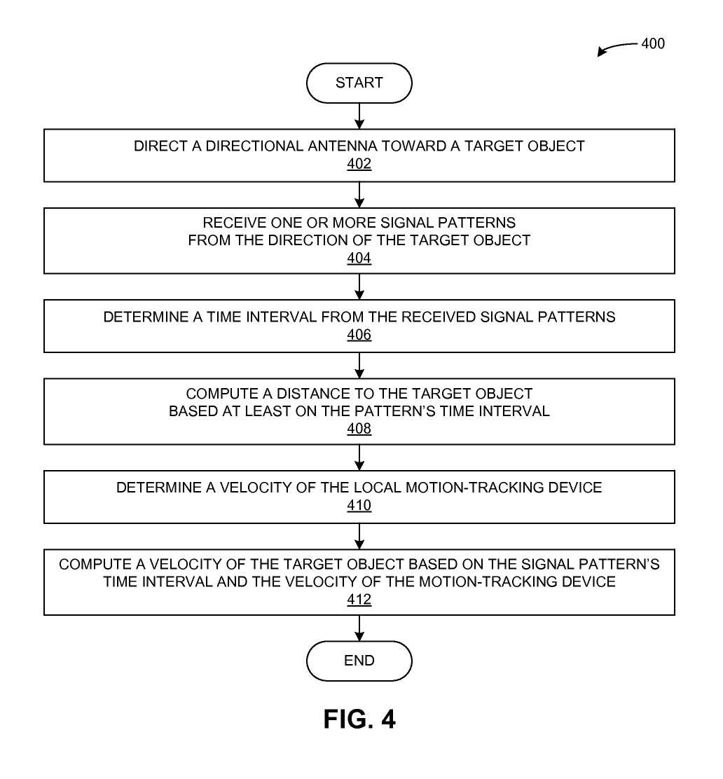

FIG. 4 presents a flow chart illustrating a method 400 for computing a distance to a target object in accordance with an embodiment. During operation, the object-tracking device can direct a directional antenna (e.g., a beam-forming antenna) toward a target objet (operation 402), and receives one or more signal patterns from the direction of the target object (operation 404). These signal patterns can include one or more RF signals transmitted by the target object (e.g., a Wi-Fi signal), or can include an infra-red signal transmitted by the object-tracking device and reflected off the target object.

The device then determines a time interval from the received signal patterns (operation 406), and computes a distance to the target object based at least on the pattern's time interval (operation 408). The device can also compute the target object's absolute velocity by determining a velocity of the local object-tracking device (operation 410), and computing the velocity of the target object based on the signal pattern's time interval and the velocity of the object-tracking device (operation 412).

In some embodiments, the target object's velocity can include its speed as well as its direction. If the target object is not moving toward or way from the object-tracking device, then the object-tracking device may need to adjust the orientation of the directional antenna to track the target object. The object-tracking device can use the change in angle during the signal's time interval (e.g., an interval between two signals transmitted by the target object from different locations) to compute the target object's speed and direction.

For example, the object-tracking device can compute a distance to the target object at one location (using a first signal pattern), and shortly thereafter (e.g., after one second) computes a distance to the target object at another location (using a second signal pattern). The local object-tracking device can compute a distance (and direction) travelled by the target object based on the distances to the two locations and the directional antenna's change in angle between the two locations. Then, the object-tracking device can compute the target object's velocity by dividing the travelled distance by the time interval between the first signal pattern and the second signal pattern.

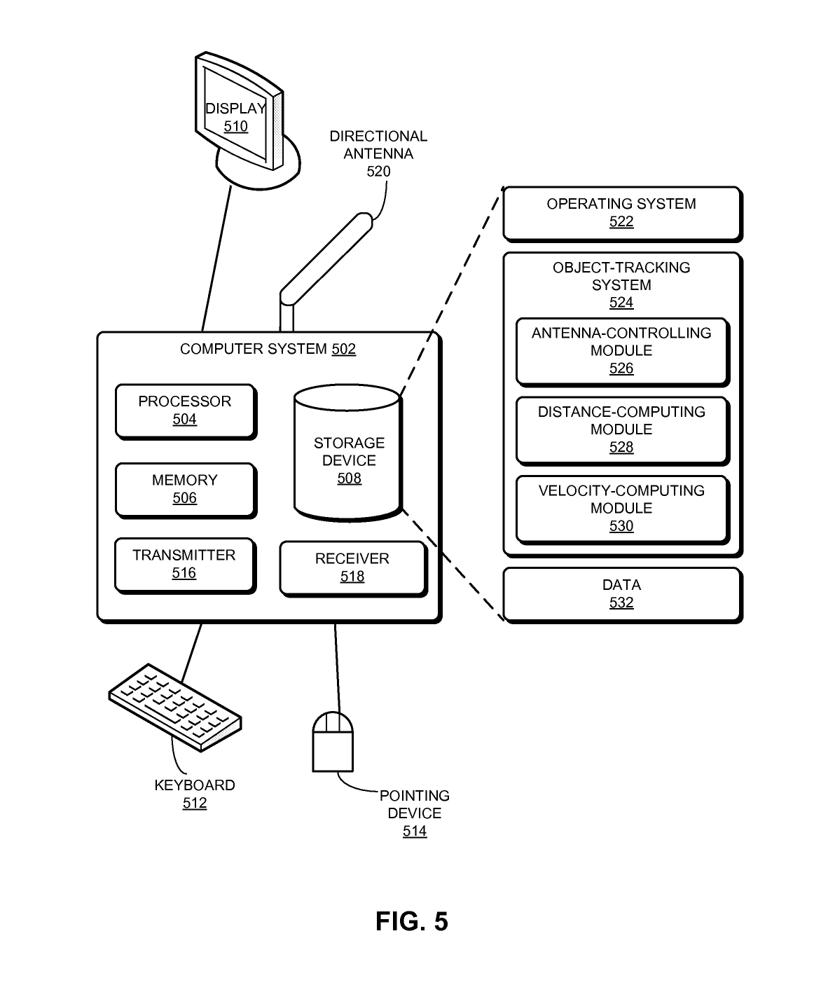

FIG. 5 illustrates an exemplary computer system 502 that facilitates computing a distance to a target object in accordance with an embodiment. Computer system 502 includes a processor 504, a memory 506, and a storage device 508. Memory 506 can include a volatile memory (e.g., RAM) that serves as a managed memory, and can be used to store one or more memory pools. Computer system 502 can also include a radio transmitter 516, a radio receiver 218, and a directional antenna 520. Radio transmitter 516 can transmit a radio frequency (RF) signal (e.g., a Wi-Fi signal), and radio receiver 518 can detect or receive the wireless RF transmitted by a transmitter of a target object. Directional antenna 520 can include a beam-forming antenna, or any antenna which can focus the incoming wireless signals to those transmitted by the target object.

Furthermore, computer system 502 can be coupled to a display device 510, a keyboard 512, and a pointing device 514. Storage device 508 can store operating system 516, an object-tracking system 524, and data 532. Object-tracking system 524 can include instructions, which when executed by computer system 502, can cause computer system 502 to perform methods and/or processes described in this disclosure.

Specifically, object-tracking system 524may include instructions for controlling the direction toward which directional antenna 520 is directed, which focuses the direction from which receiver 518 receives wireless signals (antenna-controlling module 520). Further, object-tracking system 524 can include instructions for computing a distance to a target object based on signals received from the target object (distance-computing module 522). Object-tracking system 524can also include instructions for computing a velocity and/or direction of the target object based on the signals received from the target object and the orientation of the directional antenna (velocity-computing module 524).

Data 526 can include any data that is required as input or that is generated as output by the methods and/or processes described in this disclosure.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
receiving, by an object-tracking device, a first radio signal pattern from a direction of the target object;
determining a time interval from the received radio signal pattern;
determining a velocity of the object-tracking device; and
computing, by the object-tracking device, a distance to the target object based on the time interval and the velocity of the object-tracking device.

2. The method of claim 1, further comprising directing a directional antenna toward the target object to receive radio signal patterns from the target object.

3. The method of claim 1, wherein the radio signal pattern includes a first signal pattern followed by a second signal pattern; and
wherein the time interval includes a difference between a first timestamp for the first signal pattern and a second timestamp for the second signal pattern.

4. The method of claim 1, wherein the time interval is determined from a signal frequency of the radio signal pattern.

5. The method of claim 1, further comprising:
computing a velocity of the target object, relative to a motion of the object-tracking device.

6. The method of claim 1, further comprising:
determining an adjusted time interval which accounts for the object-tracking device's motion; and
computing an absolute velocity of the target object, based on the computed distance to the target object and the adjusted time interval.

7. The method of claim 6, wherein computing the velocity involves:
determining that the object is stationary responsive to determining that the adjusted time interval matches a predetermined time interval.

8. The method of claim 1, wherein the radio signal includes one or more of:
an infrared signal transmitted by the target object;
a Wi-Fi signal transmitted by the target object; and
a light signal transmitted by the object-tracking device and reflected off the target object.

9. A non-transitory computer-readable storage medium storing instructions that when executed by a computer cause the computer to perform a method for tracking a target object by a local object-tracking device, comprising:
receiving a first radio signal pattern from a direction of the target object;
determining a time interval from the received radio signal pattern;
determining a velocity of the object-tracking device; and
computing a distance to the target object based on the time interval and the velocity of the object-tracking device.

10. The storage medium of claim 9, further comprising directing a directional antenna toward the target object to receive radio signal patterns from the target object.

11. The storage medium of claim 9, wherein the radio signal pattern includes a first signal pattern followed by a second signal pattern; and
wherein the time interval includes a difference between a first timestamp for the first signal pattern and a second timestamp for the second signal pattern.

12. The storage medium of claim 9, wherein the time interval is determined from a signal frequency of the radio signal pattern.

13. The storage medium of claim 9, further comprising:
computing a velocity of the target object, relative to a motion of the object-tracking device.

14. The storage medium of claim 9, further comprising:
determining an adjusted time interval which accounts for the object-tracking device's motion; and
computing an absolute velocity of the target object, based on the computed distance to the target object and the adjusted time interval.

15. The storage medium of claim 9, wherein the radio signal includes one or more of:
an infrared signal transmitted by the target object;
a Wi-Fi signal transmitted by the target object; and
a light signal transmitted by the object-tracking device and reflected off the target object.

16. An object-tracking apparatus for tracking a target object, the computer system comprising:
a radio receiver for receiving a first radio signal pattern from a direction of the target object; and
a distance-computing module for:
determining a time interval from the received radio signal pattern;
determining a velocity of the object-tracking apparatus; and
computing a distance to the target object based on the time interval and the velocity of the object-tracking apparatus.

17. The object-tracking apparatus of claim 16, wherein the object-tracking apparatus further comprises:
a directional antenna; and
an antenna-controlling module for directing a directional antenna toward the target object to receive radio signal patterns from the target object.

18. The object-tracking apparatus of claim 16, wherein the radio signal pattern includes a first signal pattern followed by a second signal pattern; and
wherein the time interval includes a difference between a first timestamp for the first signal pattern and a second timestamp for the second signal pattern.

19. The object-tracking apparatus of claim 16, wherein the distance-computing module determines the time interval from a signal frequency of the radio signal pattern.

20. The object-tracking apparatus of claim 16, further comprising:
a velocity-computing module configured to compute a velocity of the target object, relative to a motion of the object-tracking apparatus.

21. The object-tracking apparatus of claim 16, further comprising a velocity-computing module configured to:
determine an adjusted time interval which accounts for the motion of the object-tracking apparatus; and
compute an absolute velocity of the target object, based on the computed distance to the target object and the adjusted time interval.

22. The object-tracking apparatus of claim 16, wherein the radio signal includes one or more of:
an infrared signal transmitted by the target object;
a Wi-Fi signal transmitted by the target object; and
a light signal transmitted by the object-tracking apparatus and reflected off the target object.
